(19) United States
(12) Patent Application Publication
(10) Pub. No.: US 2025/0113406 A1
(43) Pub. Date: Apr. 3, 2025

(54) INTERFACE FAILURE RECOVERY SUCH AS FOR N3MB WITH MONOLITHIC OR SPLIT ACCESS NODES

(71) Applicant: Nokia Technologies Oy, Espoo (FI)

(72) Inventors: Philippe GODIN, Massy (FR); Bruno LANDAIS, Lannion (FR); Horst Thomas BELLING, Munich (DE); Salman NADAF, Munich (DE); Ugur Baran ELMALI, Munich (DE)

(21) Appl. No.: 18/896,324

(22) Filed: Sep. 25, 2024

Related U.S. Application Data
(60) Provisional application No. 63/541,142, filed on Sep. 28, 2023.

(51) Int. Cl. H04W 76/40; H04W 76/30; H04W 84/04

(52) U.S. Cl. CPC H04W 76/40; H04W 76/30; H04W 84/042

(57) ABSTRACT

A network access node receives an indication of an interval between expected receptions of echo requests that pass through a tunnel that uses an interface between a network element in a core network of the cellular network to the network access node of the cellular network. The network access node determines a threshold time period based on the interval, detects there has been no echo request for a time period greater than the threshold time period, and determines that a failure has occurred of the tunnel that uses the interface. The network access node triggers set up of a new tunnel using the interface due to the failure of the tunnel. Multiple techniques are disclosed for determining that this failure has occurred and recovering from the failure, including setting up a new MBS session or using a new transport address for a current MBS session.

### RELATED APPLICATIONS

This application claims the benefit of priority of U.S. Provisional Patent Application No. 63/541,142 filed Sep. 28, 2023, which is hereby incorporated by reference.

### TECHNICAL FIELD

Examples of embodiments herein relate generally to wireless networks and, more specifically, relate to failure recovery for interfaces in MBS (Multicast and Broadcast Services).

### BACKGROUND

Multicast and Broadcast Services (MBS) is technique used in wireless systems such as cellular systems so that broadcast or multicast services can be communicated from a network element in a core network of the cellular system to an access node in the cellular system. The access node provides access by user equipment (UEs) to the cellular system and would be the end consumer of the services.

The various network elements are interconnected through links and on those links run interfaces, which have known protocols used for the communications between the elements. These interfaces may use tunnels, which are instances of the interface that support the corresponding protocol and the broadcast session. The tunnels have starting and ending points, such as one network element of the user plane and an access node. Sometimes, the tunnels, and therefore the interface, for a broadcast session can fail. It is important when this happens that this event can be recovered from.

### BRIEF SUMMARY

This section is intended to include examples and is not intended to be limiting.

In an exemplary embodiment, a method is disclosed that includes receiving, by a network access node in a cellular network, an indication of an interval between expected receptions of echo requests that pass through a tunnel that uses an interface between a network element in a core network of the cellular network to the network access node of the cellular network; determining, by the network access node, a threshold time period based on the interval; detecting, by the network access node, there has been no echo request for a time period greater than the threshold time period; determining, by the network access node from the detecting, a failure of the tunnel that uses the interface; and triggering, by the network access node, set up of a new tunnel using the interface due to the failure of the tunnel.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, by a network access node in a cellular network, an indication of an interval between expected receptions of echo requests that pass through a tunnel that uses an interface between a network element in a core network of the cellular network to the network access node of the cellular network; determining, by the network access node, a threshold time period based on the interval; detecting, by the network access node, there has been no echo request for a time period greater than the threshold time period; determining, by the network access node from the detecting, a failure of the tunnel that uses the interface; and triggering, by the network access node, set up of a new tunnel using the interface due to the failure of the tunnel.

An exemplary computer program product includes a computer-readable storage medium bearing instructions that, when executed by an apparatus, cause the apparatus to perform at least the following: receiving, by a network access node in a cellular network, an indication of an interval between expected receptions of echo requests that pass through a tunnel that uses an interface between a network element in a core network of the cellular network to the network access node of the cellular network; determining, by the network access node, a threshold time period based on the interval; detecting, by the network access node, there has been no echo request for a time period greater than the threshold time period; determining, by the network access node from the detecting, a failure of the tunnel that uses the interface; and triggering, by the network access node, set up of a new tunnel using the interface due to the failure of the tunnel.

In another exemplary embodiment, an apparatus comprises means for performing: receiving, by a network access node in a cellular network, an indication of an interval between expected receptions of echo requests that pass through a tunnel that uses an interface between a network element in a core network of the cellular network to the network access node of the cellular network; determining, by the network access node, a threshold time period based on the interval; detecting, by the network access node, there has been no echo request for a time period greater than the threshold time period; determining, by the network access node from the detecting, a failure of the tunnel that uses the interface; and triggering, by the network access node, set up of a new tunnel using the interface due to the failure of the tunnel.

In an exemplary embodiment, a method is disclosed that includes receiving, from a first network element in a core network of a cellular network and by a second network element in the core network, an indication that a tunnel for an interface used for communicating an MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further requesting a release of the MBS session.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, from a first network element in a core network of a cellular network and by a second network element in the core network, an indication that a tunnel for an interface used for communicating an MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further requesting a release of the MBS session.

An exemplary computer program product includes a computer-readable storage medium bearing instructions that, when executed by an apparatus, cause the apparatus to perform at least the following: receiving, from a first network element in a core network of a cellular network and by a second network element in the core network, an indication that a tunnel for an interface used for communicating an MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further requesting a release of the MBS session.

In another exemplary embodiment, an apparatus comprises means for performing: receiving, from a first network element in a core network of a cellular network and by a second network element in the core network, an indication that a tunnel for an interface used for communicating an MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further requesting a release of the MBS session.

In an exemplary embodiment, a method is disclosed that includes receiving, by a network access node using a tunnel of an interface for communicating an MBS session between the network access node and a first network element in a core network and from a second network node via a third network element in the core network, an indication that the tunnel has failed, the indication further indicating the MBS session is to be released; releasing, by the network access node, the MBS session; and sending, by the network access node toward a second network element via the third network element in the core network, indication that the interface is no longer being used for this MBS session and that the MBS session is released.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, by a network access node using a tunnel of an interface for communicating an MBS session between the network access node and a first network element in a core network and from a second network node via a third network element in the core network, an indication that the tunnel has failed, the indication further indicating the MBS session is to be released; releasing, by the network access node, the MBS session; and sending, by the network access node toward a second network element via the third network element in the core network, indication that the interface is no longer being used for this MBS session and that the MBS session is released.

An exemplary computer program product includes a computer-readable storage medium bearing instructions that, when executed by an apparatus, cause the apparatus to perform at least the following: receiving, by a network access node using a tunnel of an interface for communicating an MBS session between the network access node and a first network element in a core network and from a second network node via a third network element in the core network, an indication that the tunnel has failed, the indication further indicating the MBS session is to be released; releasing, by the network access node, the MBS session; and sending, by the network access node toward a second network element via the third network element in the core network, indication that the interface is no longer being used for this MBS session and that the MBS session is released.

In another exemplary embodiment, an apparatus comprises means for performing: receiving, by a network access node using a tunnel of an interface for communicating an MBS session between the network access node and a first network element in a core network and from a second network node via a third network element in the core network, an indication that the tunnel has failed, the indication further indicating the MBS session is to be released; releasing, by the network access node, the MBS session; and sending, by the network access node toward a second network element via the third network element in the core network, indication that the interface is no longer being used for this MBS session and that the MBS session is released.

In an exemplary embodiment, a method is disclosed that includes receiving, from a first network element in a core network of a cellular network and by a second network element in the core network, an indication that a tunnel for an interface used for communicating a MBS session between a network access node and the first network element has failed, the indication comprising indication of an address associated with the network access node using the tunnel; retrieving, by the second network element, an identification of the network access node based on the address; and indicating, by the second network element to a third network element for forwarding to the network access node, at least one of failure of the tunnel in the core network, or a request for a new transport address of the network access node for use as new tunnel endpoint for the MBS session.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, from a first network element in a core network of a cellular network and by a second network element in the core network, an indication that a tunnel for an interface used for communicating a MBS session between a network access node and the first network element has failed, the indication comprising indication of an address associated with the network access node using the tunnel; retrieving, by the second network element, an identification of the network access node based on the address; and indicating, by the second network element to a third network element for forwarding to the network access node, at least one of failure of the tunnel in the core network, or a request for a new transport address of the network access node for use as new tunnel endpoint for the MBS session.

An exemplary computer program product includes a computer-readable storage medium bearing instructions that, when executed by an apparatus, cause the apparatus to perform at least the following: receiving, from a first network element in a core network of a cellular network and by a second network element in the core network, an indication that a tunnel for an interface used for communicating a MBS session between a network access node and the first network element has failed, the indication comprising indication of an address associated with the network access node using the tunnel; retrieving, by the second network element, an identification of the network access node based on the address; and indicating, by the second network element to a third network element for forwarding to the network access node, at least one of failure of the tunnel in the core network, or a request for a new transport address of the network access node for use as new tunnel endpoint for the MBS session.

In another exemplary embodiment, an apparatus comprises means for performing: receiving, from a first network element in a core network of a cellular network and by a second network element in the core network, an indication that a tunnel for an interface used for communicating a MBS session between a network access node and the first network element has failed, the indication comprising indication of an address associated with the network access node using the tunnel; retrieving, by the second network element, an identification of the network access node based on the address; and indicating, by the second network element to a third network element for forwarding to the network access node, at least one of failure of the tunnel in the core network, or a request for a new transport address of the network access node for use as new tunnel endpoint for the MBS session.

In an exemplary embodiment, a method is disclosed that includes receiving, by a network access node using a tunnel of an interface for communicating a MBS session between the network access node and a first network element in a core network and from a second network node via a third network element in the core network, at least one of an indication that the tunnel has failed, or an indication indicating a request for a new transport address to be used as tunnel endpoint for the MBS session; determining, by the network access node, a new transport address associated with the MBS session; and sending, by the network access node toward a second network element via the third network element in the core network, indication of the new transport address that is associated with the MBS session to be used as new tunnel endpoint for the communicating between the first network element and the network access node.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, by a network access node using a tunnel of an interface for communicating a MBS session between the network access node and a first network element in a core network and from a second network node via a third network element in the core network, at least one of an indication that the tunnel has failed, or an indication indicating a request for a new transport address to be used as tunnel endpoint for the MBS session; determining, by the network access node, a new transport address associated with the MBS session; and sending, by the network access node toward a second network element via the third network element in the core network, indication of the new transport address that is associated with the MBS session to be used as new tunnel endpoint for the communicating between the first network element and the network access node.

An exemplary computer program product includes a computer-readable storage medium bearing instructions that, when executed by an apparatus, cause the apparatus to perform at least the following: receiving, by a network access node using a tunnel of an interface for communicating a MBS session between the network access node and a first network element in a core network and from a second network node via a third network element in the core network, at least one of an indication that the tunnel has failed, or an indication indicating a request for a new transport address to be used as tunnel endpoint for the MBS session; determining, by the network access node, a new transport address associated with the MBS session; and sending, by the network access node toward a second network element via the third network element in the core network, indication of the new transport address that is associated with the MBS session to be used as new tunnel endpoint for the communicating between the first network element and the network access node.

In another exemplary embodiment, an apparatus comprises means for performing: receiving, by a network access node using a tunnel of an interface for communicating a MBS session between the network access node and a first network element in a core network and from a second network node via a third network element in the core network, at least one of an indication that the tunnel has failed, or an indication indicating a request for a new transport address to be used as tunnel endpoint for the MBS session; determining, by the network access node, a new transport address associated with the MBS session; and sending, by the network access node toward a second network element via the third network element in the core network, indication of the new transport address that is associated with the MBS session to be used as new tunnel endpoint for the communicating between the first network element and the network access node.

In an exemplary embodiment, a method is disclosed that includes receiving, from a first network element in a core network of a cellular network and by a second network element in the core network, an indication that a tunnel for an interface used for communicating an MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further having a notification about the MBS session being associated with the tunnel has failed.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, from a first network element in a core network of a cellular network and by a second network element in the core network, an indication that a tunnel for an interface used for communicating an MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further having a notification about the MBS session being associated with the tunnel has failed.

An exemplary computer program product includes a computer-readable storage medium bearing instructions that, when executed by an apparatus, cause the apparatus to perform at least the following: receiving, from a first network element in a core network of a cellular network and by a second network element in the core network, an indication that a tunnel for an interface used for communicating an MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further having a notification about the MBS session being associated with the tunnel has failed.

In another exemplary embodiment, an apparatus comprises means for performing: receiving, from a first network element in a core network of a cellular network and by a second network element in the core network, an indication that a tunnel for an interface used for communicating an MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further having a notification about the MBS session being associated with the tunnel has failed.

In an exemplary embodiment, a method is disclosed that includes receiving, by a network access node using a tunnel of an interface for communicating an MBS session between the network access node and a first network element in a core network and from a second network element via a third network element in the core network, an indication that the tunnel has failed; determining, by the network access node, to release a current transport address associated with the MBS session and get a new transport address for the MBS session; and setting up, by the network access node, a new tunnel that uses the interface used for communicating the MBS session with a current PLMN for the core network or an other PLMN for an other core network; and sending, by the network access node toward one of a second network element in the core network of the current PLMN or a second network element in the other core network of the other PLMN, indication of the new transport address to be used with the new tunnel for the MBS session.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, by a network access node using a tunnel of an interface for communicating an MBS session between the network access node and a first network element in a core network and from a second network element via a third network element in the core network, an indication that the tunnel has failed; determining, by the network access node, to release a current transport address associated with the MBS session and get a new transport address for the MBS session; and setting up, by the network access node, a new tunnel that uses the interface used for communicating the MBS session with a current PLMN for the core network or an other PLMN for an other core network; and sending, by the network access node toward one of a second network element in the core network of the current PLMN or a second network element in the other core network of the other PLMN, indication of the new transport address to be used with the new tunnel for the MBS session.

An exemplary computer program product includes a computer-readable storage medium bearing instructions that, when executed by an apparatus, cause the apparatus to perform at least the following: receiving, by a network access node using a tunnel of an interface for communicating an MBS session between the network access node and a first network element in a core network and from a second network element via a third network element in the core network, an indication that the tunnel has failed; determining, by the network access node, to release a current transport address associated with the MBS session and get a new transport address for the MBS session; and setting up, by the network access node, a new tunnel that uses the interface used for communicating the MBS session with a current PLMN for the core network or an other PLMN for an other core network; and sending, by the network access node toward one of a second network element in the core network of the current PLMN or a second network element in the other core network of the other PLMN, indication of the new transport address to be used with the new tunnel for the MBS session.

In another exemplary embodiment, an apparatus comprises means for performing: receiving, by a network access node using a tunnel of an interface for communicating an MBS session between the network access node and a first network element in a core network and from a second network element via a third network element in the core network, an indication that the tunnel has failed; determining, by the network access node, to release a current transport address associated with the MBS session and get a new transport address for the MBS session; and setting up, by the network access node, a new tunnel that uses the interface used for communicating the MBS session with a current PLMN for the core network or another PLMN for another core network; and sending, by the network access node toward one of a second network element in the core network of the current PLMN or a second network element in the other core network of the other PLMN, indication of the new transport address to be used with the new tunnel for the MBS session.

In an exemplary embodiment, a method is disclosed that includes second network element in the core network, an indication that a tunnel for an interface used for communicating a MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further having a notification about the MBS session being associated with the tunnel has failed and requesting release of the MBS session.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: second network element in the core network, an indication that a tunnel for an interface used for communicating a MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further having a notification about the MBS session being associated with the tunnel has failed and requesting release of the MBS session.

An exemplary computer program product includes a computer-readable storage medium bearing instructions that, when executed by an apparatus, cause the apparatus to perform at least the following: second network element in the core network, an indication that a tunnel for an interface used for communicating a MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further having a notification about the MBS session being associated with the tunnel has failed and requesting release of the MBS session.

In another exemplary embodiment, an apparatus comprises means for performing: second network element in the core network, an indication that a tunnel for an interface used for communicating a MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further having a notification about the MBS session being associated with the tunnel has failed and requesting release of the MBS session.

In an exemplary embodiment, a method is disclosed that includes receiving, by a network access node using a tunnel of an interface for communicating a MBS session between the network access node and a first network element in a core network and from a second network element via a third network element in the core network, an indication that the tunnel has failed and requesting release of the MBS session; determining, by the network access node, to release a current transport address associated with the MBS session and get a new transport address for the MBS session; and setting up, by the network access node, a new tunnel that uses the interface used for communicating the MBS session toward one of a second network element in the core network of a current PLMN or a second network element in the core network of another PLMN; and sending, by the network access node toward the one of a second network element in the core network for the current PLMN or the one of a second network element in the other core network for the other PLMN, indication of the new transport address to be used with the new tunnel for the MBS session.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, by a network access node using a tunnel of an interface for communicating a MBS session between the network access node and a first network element in a core network and from a second network element via a third network element in the core network, an indication that the tunnel has failed and requesting release of the MBS session; determining, by the network access node, to release a current transport address associated with the MBS session and get a new transport address for the MBS session; and setting up, by the network access node, a new tunnel that uses the interface used for communicating the MBS session toward one of a second network element in the core network of a current PLMN or a second network element in the core network of another PLMN; and sending, by the network access node toward the one of a second network element in the core network for the current PLMN or the one of a second network element in the other core network for the other PLMN, indication of the new transport address to be used with the new tunnel for the MBS session.

An exemplary computer program product includes a computer-readable storage medium bearing instructions that, when executed by an apparatus, cause the apparatus to perform at least the following: receiving, by a network access node using a tunnel of an interface for communicating a MBS session between the network access node and a first network element in a core network and from a second network element via a third network element in the core network, an indication that the tunnel has failed and requesting release of the MBS session; determining, by the network access node, to release a current transport address associated with the MBS session and get a new transport address for the MBS session; and setting up, by the network access node, a new tunnel that uses the interface used for communicating the MBS session toward one of a second network element in the core network of a current PLMN or a second network element in the core network of another PLMN; and sending, by the network access node toward the one of a second network element in the core network for the current PLMN or the one of a second network element in the other core network for the other PLMN, indication of the new transport address to be used with the new tunnel for the MBS session.

In another exemplary embodiment, an apparatus comprises means for performing: receiving, by a network access node using a tunnel of an interface for communicating a MBS session between the network access node and a first network element in a core network and from a second network element via a third network element in the core network, an indication that the tunnel has failed and requesting release of the MBS session; determining, by the network access node, to release a current transport address associated with the MBS session and get a new transport address for the MBS session; and setting up, by the network access node, a new tunnel that uses the interface used for communicating the MBS session toward one of a second network element in the core network of a current PLMN or a second network element in the core network of another PLMN; and sending, by the network access node toward the one of a second network element in the core network for the current PLMN or the one of a second network element in the other core network for the other PLMN, indication of the new transport address to be used with the new tunnel for the MBS session.

### BRIEF DESCRIPTION OF THE DRAWINGS

In the attached drawings:

FIG. 1 is a signaling diagram for an example referred to as embodiment 1 for N3 MB failure recovery;

FIG. 2A is a signaling diagram for an example referred to as embodiment 2a for N3 MB failure recovery with a non-RAN-sharing case;

FIG. 2B is a signaling diagram for an example referred to as embodiment 2b for N3 MB failure recovery with a non-RAN-sharing case;

FIG. 2C is a signaling diagram for an example referred to as embodiment 2c for N3 MB failure recovery with a RAN-sharing and a non-RAN-sharing case;

FIG. 2D is a signaling diagram for an example referred to as embodiment 2d for N3 MB failure recovery with a RAN-sharing and a non-RAN-sharing case; and

FIG. 3 is a block diagram of one possible and non-limiting exemplary system in which the exemplary embodiments may be practiced.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”. As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

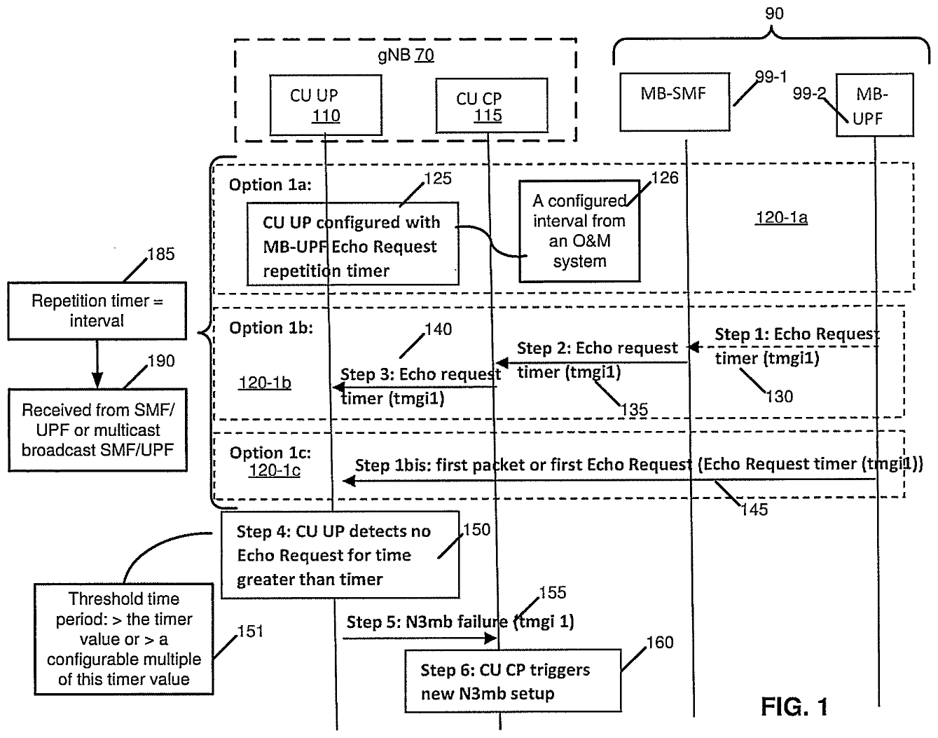

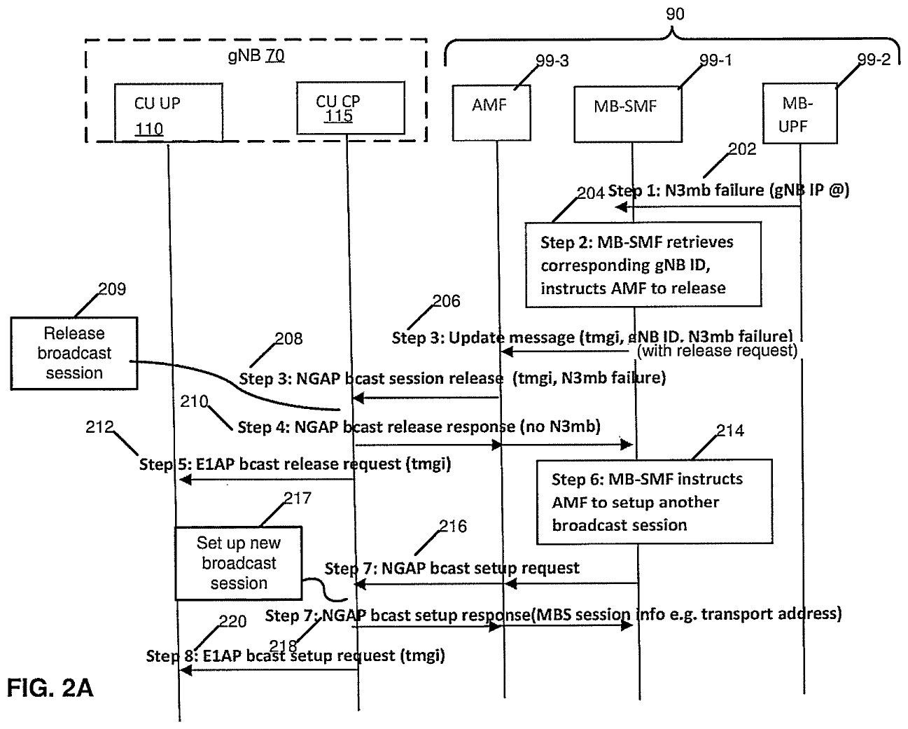

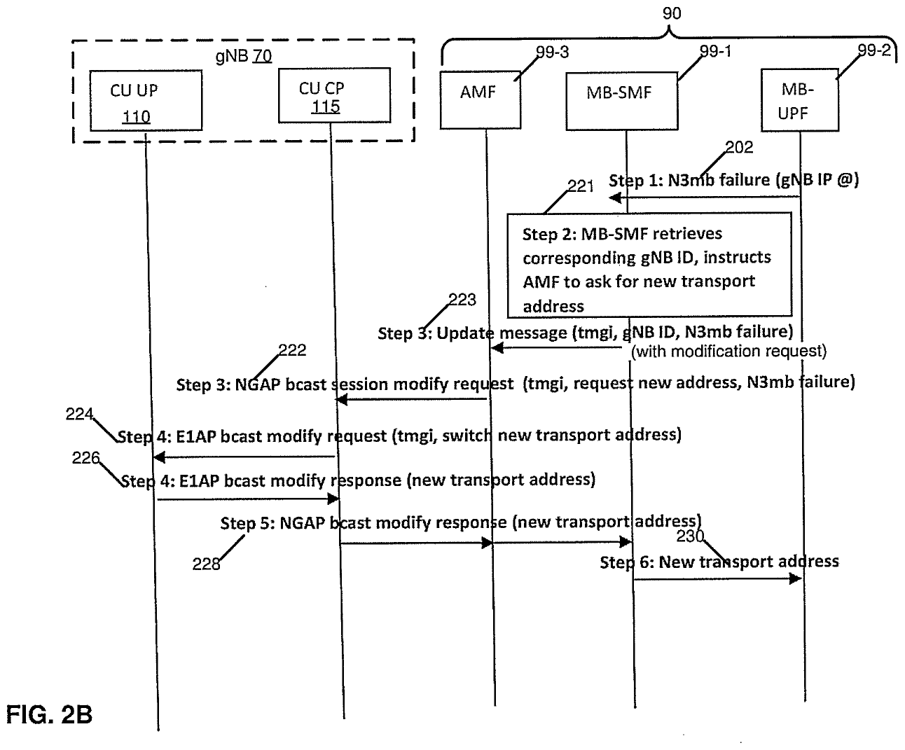

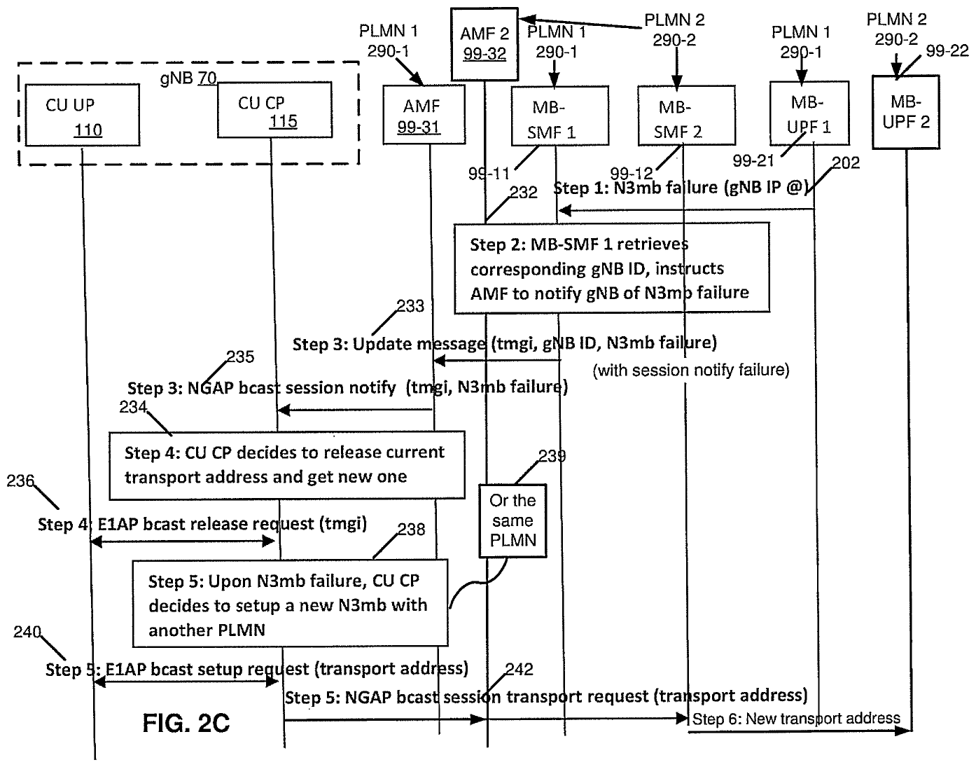

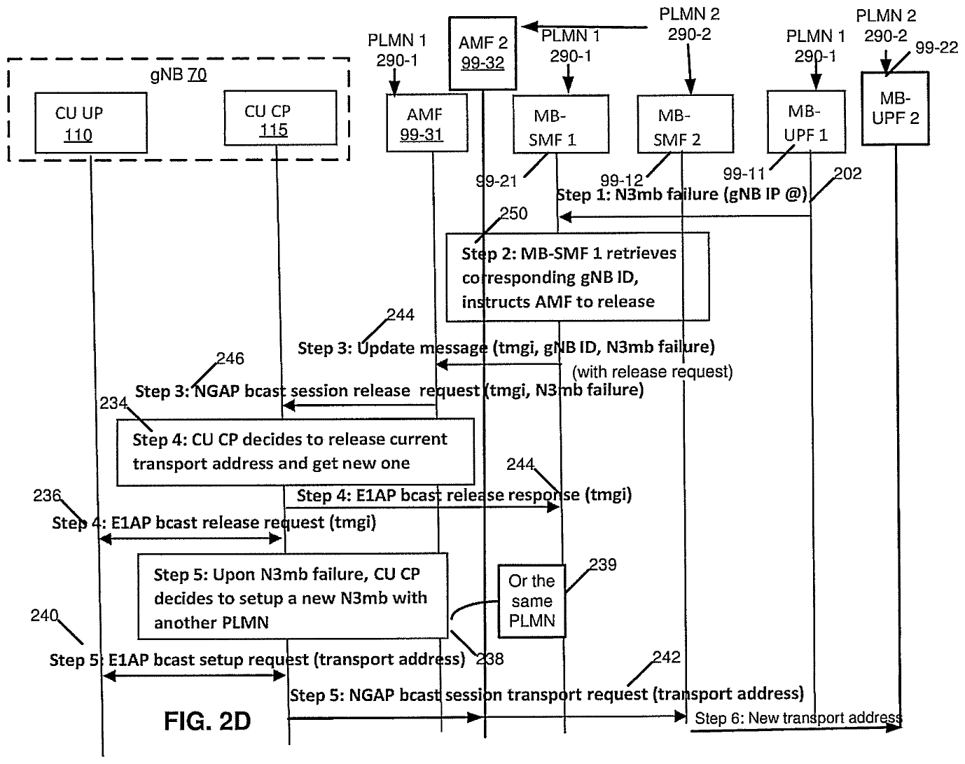

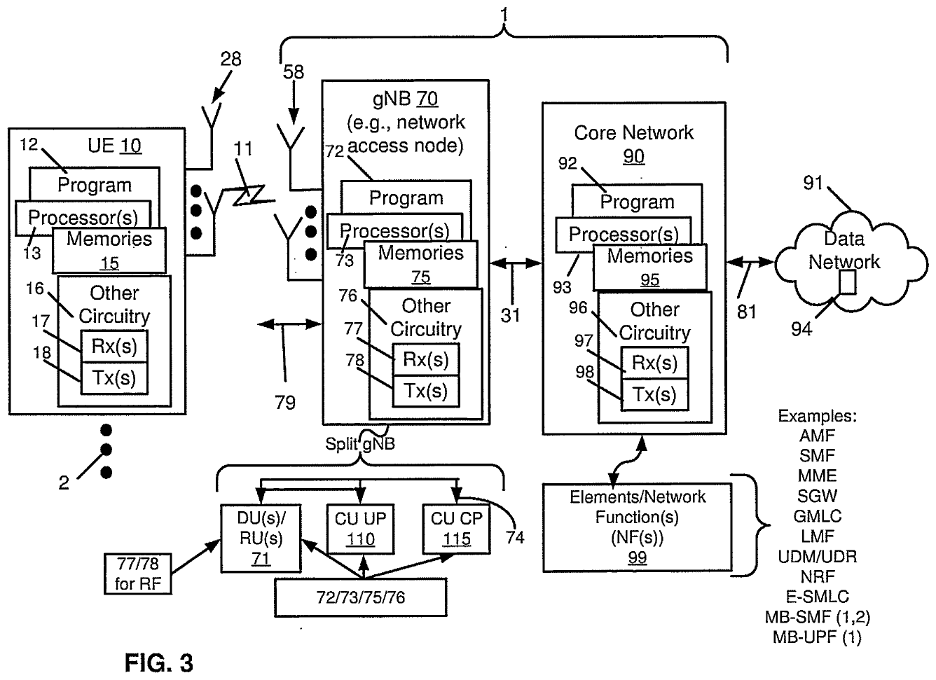

Any flow diagram or signaling diagram (see FIGS. 1, 2A, 2B, 2C, and 2D) herein is considered to be a logic flow diagram, and illustrates the operation of an exemplary method, results of execution of computer program instructions embodied on a computer readable memory, functions performed by logic implemented in hardware, and/or interconnected means for performing functions in accordance with an exemplary embodiment. Block diagrams (such as FIG. 3) also illustrate the operation of an exemplary method, results of execution of computer program instructions embodied on a computer readable memory, functions performed by logic implemented in hardware, and/or interconnected means for performing functions in accordance with an exemplary embodiment.

An overview of the technological area is now provided.

There has been the possibility of a split gNB since release 15. As is known, a gNB is a network element that provides access by UEs to a cellular network. The gNB may also be referred to as a NG-RAN, a new generation-radio access network, where the RAN provides the access by the UEs to the cellular network. Since release 15, a gNB can be split between CU (central unit) containing higher layer protocol and DU (distributed unit) containing lower layer protocol. Furthermore, the CU can be itself split into a control plane part named as a CU-CP, and into a user plane part named as a CU-UP.

A topic of interest is Multicast and Broadcast Services (MBS) in Rel-17. 3GPP finalized a work item (see RP-193248, Huawei, “New Work Item on NR support of Multicast and Broadcast Services”, 3GPP TSG RAN Meeting #86, Sitges, Spain, December 9th-12th, 2019) for support of Multicast and Broadcast Systems (MBS) in Release 17 New Radio (NR). Herein, Point to Multi-Point (PTM) transmission is expected to efficiently provision MBS services to multiple users by using the same radio framework as unicast transmission. Rel-17 enabled the reception of a multicast service by the UEs in the RRC_CONNECTED state, only. In addition, Rel-17 specified broadcast reception in all RRC states.

According to 3GPP TS 23.247 (see, e.g., 3GPP TS 23.247 V18.3.0 (2023-09)), the delivery of MBS data from 5GC to NG-RAN is done over the N3mb interface from the MB-UPF to the gNB. The data can be delivered over the N3mb interface, either over unicast transport or over multicast transport.

For broadcast sessions in release 17, the N3mb setup is always triggered top-down, i.e., the AMF sends a broadcast setup request to the gNB to set up a broadcast session context and the gNB sends back a transport address for a corresponding N3mb communication.

A further topic of interest is MBS in Rel-18. In release 18, 3GPP agreed a further work item (see RP-231829, CATT, CBN, “Revised WID: Enhancements of NR Multicast and Broadcast Services”, 3GPP TSG RAN Meeting #101, Bangalore, India, Sep. 11-15, 2023) for support of Multicast and Broadcast Systems (MBS) including RAN3 work as follows:

“Study and if necessary, specify enhancements to improve the resource efficiency for MBS broadcast reception in RAN sharing scenarios [RAN3]”.

The “resource efficiency in RAN sharing” feature includes sharing the radio resources of all the participants of the RAN sharing. The feature is also called “RAN sharing resource usage”.

As part of this new release 18 feature of resource efficiency for RAN sharing, RAN3 has agreed that gNB can decide to set up one or more N3mb tunnels towards the 5GC of the different PLMNs participating in the RAN sharing. For example, if RAN sharing involves PLMN1, PLMN2, PLMN3 then gNB can decide to setup N3mb only with 5GC1 for PLMN1, or for both 5GC1 for PLM1 and 5GC2 for PLMN2, or for the three 5GC1, 5GC2, 5GC3 for PLMN 1,2,3. It is the gNB's decision.

As part of this new release 18 feature of resource efficiency for RAN sharing, also called “RAN sharing resource usage”, RAN3 has also agreed that the N3mb can be newly set up also bottom-up, i.e., triggered by gNB. This was motivated by the previous agreement that gNB decides the number of N3mb tunnels the gNB wants and to answer the following scenario: In the case where the gNB would decide to set up only one N3mb with 5GC1 for PLMN1 (e.g., to avoid redundancy over N3mb) while radio resources are being shared among PLMN1, PLMN2, PLMN3, it is possible that 5GC1 decides to release the broadcast session while 5GC2, 5GC3 wants to continue the broadcast session towards the UEs over PLMN2 and PLMN3. 5GC1 would then release the broadcast session, which would release the N3mb between gNB and 5GC1, meaning that there is no N3mb for gNB to receive the data to be delivered towards the UEs over PLMN2 and PLMN3. In this situation, the gNB can newly trigger set up of a new N3mb towards 5GC2 of PLMN2 or 5GC3 of PLMN3 in order for the gNB to receive the broadcast data from respectively MB-UPF2 of PLMN2 or MB-UPF3 of PLMN3.

Now that an overview of the technology area has been provided, a description of problems in this area is provided. As part of the new release 18 feature of “resource efficiency for RAN sharing” (described above), Samsung in R3-233948 (see R3-233948, Samsung, “(TP for BLCR TS37.483) Discussion on MBS RAN sharing”, 3GPP TSG-RAN WG3 #12, Toulouse, France, 21-25 Aug. 2023) has addressed the use case that the N3mb could fail in the special case where a gNB is split between control plane gNB-CU-CP and user plane gNB-CU-UP.

In the scenario where the gNB is shared between three PLMN1, PLMN2, PLMN3 and the gNB had decided to setup only the N3mb towards 5GC1 of PLMN1 (see above) the gNB needs to trigger the setup of N3mb towards 5GC2 of PLMN2 or 5GC3 of PLMN3 in replacement but this setup is triggered by gNB-CU CP who is not aware of the N3mb failure with 5GC1.

Samsung proposes that gNB-CU UP informs the gNB-CU CP of the failure in the user plane N3mb so that gNB-CU-CP can trigger the setup of N3mb towards 5GC2 or 5GC3 in replacement. See Tdoc R3-233948:

“If the NG-RAN is the split architecture, for the second trigger, only the gNB-CU-UP is aware if there is DL data stream from the CN. Therefore the new message should be triggered by the gNB-CU-UP originally. The gNB-CU-UP notifies there is no data transmission to the gNB-CU-CP due to failure in the user plane. Then the gNB CU-CP can send the message to another core network.”

It is noted that the “second trigger” in Samsung is the following: “When the shared NG-RAN fails to receive DL data stream from the CN (e.g., due to failure in the user plane), the NG-RAN attempts to get the DL data stream via another CN's user plane.”

This still creates a problem, as described below.

One main problem to be solved is how to recover in MBS from a failure of user plane N3mb in a gNB. This problem may be solved for both:
1) a monolithic gNB, and
2) a split gNB (i.e., with an open E1 interface between the gNB-CU CP and the gNB-CU UP).

The problem may also be solved:
1) when “resource efficiency for RAN sharing” (or “RAN sharing resource usage”) does not apply (before new release 18 feature), and
2) when “resource efficiency for RAN sharing” (or “RAN sharing resource usage”) applies (new release 18 feature used).

Samsung in R3-233948 relies on gNB-CU UP detecting that there is no data transmission and informing the gNB-CU CP, then the gNB-CU CP triggers again a new setup of N3mb towards 5GC. Note also that Samsung R3-233948 only covers the RAN sharing case with the gNB-CU CP triggering the setup of N3mb towards the 5GC of another PLMN participating in the RAN sharing.

However, the techniques in Samsung might not work, because no data being received by gNB-CU UP or gNB does not necessarily mean that N3mb is failed and should be restored. Instead, no data being received can simply be due to some pause in the delivery of data from the broadcast application function.

It should also be appreciated that a solution for gNB-CU UP or gNB to detect the N3mb failure is not trivial in the case of broadcast session delivery. This is because 3GPP has decided that, for broadcast, the gNB will not be provided with an uplink transport address for the N3mb tunnel due to the fact that the MBS data delivery is only downlink. However, this 3GPP decision also indirectly means that a gNB-CU UP or gNB cannot send the GTP echo request message that is normally used by a 3GPP node to detect a user plane failure (see 3GPP TS 29.281, e.g., 3GPP TS 29.281 V18.0.0 (2023-06), in section 7.2.1).

In terms of the terminology used herein, the term “N3mb” is used to refer to the path or GTP tunnel over an N3mb interface used by a particular broadcast session for the data stream delivery. The term “N3mb failure” is used to refer to a failure of the path or GTP tunnel over the N3mb interface used by a particular broadcast session for the data stream delivery.

The examples herein propose to address at least the above problems in multiple possible ways, described in two main embodiments along with their corresponding sub-embodiments. It is noted that all the description which follows is written for the general case of a split gNB (i.e., with gNB-CU CP and gNB-CU UP), however the examples also fully apply to case of monolithic (non-split) gNB by considering all the inter-actions reported here-below between gNB-CU CP and gNB-CU UP as internal to the gNB (i.e., not over an open E1 interface).

A first example embodiment (referred to as embodiment 1 herein) is described first. This example introduces a means to help gNB-CU UP or gNB to detect the N3mb failure. This example uses FIG. 1, which is a signaling diagram for an example referred to as embodiment 1 for N3 MB failure recovery. FIG. 1 illustrates a CU UP 110, a CU CP 115, an MB-SMF 99-1, and an MB-UPF 99-2. As previously described, the access node of the gNB 70 may be monolithic, or may be partitioned as shown into a split gNB 70 as illustrated with the CU UP 110 and the CU CP 115. The MB-SMF 99-1 and MB-UPF 99-2 are examples of core network 90 elements 99, which can be also referred to as network functions.

As explained above, the gNB-CU UP 110 cannot send the GTP echo request to detect the N3mb failure (“N3mb failure” in the following will stand for a failure of the path or GTP tunnel over N3mb interface used by a (the) broadcast session for the data stream delivery), however the gNB-CU UP 110 can receive the echo request generated by an MB-UPF 99-2, which monitors the N3mb (“N3mb” in the following will refer to the path or GTP tunnel over N3mb used by a (the) broadcast session for the data stream delivery). If the MB-UPF 99-2 monitors the N3mb, the MB-UPF 99-2 will send echo request messages towards the gNB 70 at regular intervals, e.g., every three minutes. If the gNB-CU UP 110 could be aware of this interval, the gNB-CU UP 110 would be able to notice that echo request from the MB-UPF 99-2 has not been received since more than three minutes and therefore infer that N3mb is failed. To cope with the possible loss of one echo request, the gNB may also infer that N3mb has failed after not receiving more than one (i.e., multiple) consecutive echo request message(s).

The embodiment 1 therefore includes the gNB-CU UP 110 learning the repetition timer of the MB-UPF sending echo request and detecting N3mb failure based on that. There are three examples for this.

In Option 1a 120-1a, the gNB-CU UP is configured with the MB-UPF repetition timer value for echo request and detects the N3mb failure using this value. The gNB-CU UP is configured with MB-UPF repetition timer value for echo request in block 125, it can be per TMGI (i.e., per broadcast session). The MB-UPF repetition timer value used herein is considered to be an indication of an interval between expected receptions of echo requests that pass through a tunnel formed using the N3mb. See block 185. This also applies to Options 1b and 1c. As indicated by block 126, wherein the configuring can result in an interval comprising a configured interval to be used as an O&M (operation and maintenance) system. Although a broadcast session is used in the examples herein, more generally, an MBS session can be used. For instance, the configuration can be per MBS session instead of per broadcast session. Furthermore, the interval may be received from an SMF, a multicast broadcast SMF, a UPF, or a multicast broadcast UPF. See block 190.

The gNB-CU UP 110 detects the N3mb failure using this timer value at step 4, block 150, in response to detecting that the duration since it has received the last Echo Request from MB-UPF is greater than (>) the timer value or greater than (>) a configurable multiple of this timer value, see block 151. In block 151, this is considered The CU UP 110 notifies the gNB-CU CP 115 at step 5, signaling 155, using an indication of an N3mb failure with an indication of the involved MBS session identified by its Temporary Mobile Group Identity (e.g., “TMGI 1”). The gNB-CU CP 115 triggers the new N3mb setup at step 6, block 160. Trigger N3mb setup in all the following refers to triggering set up of a GTP tunnel over N3mb interface to be used for the broadcast session data stream delivery.

In Option 1b, the gNB-CU CP receives the MB-UPF repetition timer value for the echo request from the MB-SMF 99-1 at step 2. The MB-SMF 99-1 has either been configured with this timer value or has received indication of the value to use for the timer from the MB-UPF 99-2 earlier at step 1. The gNB-CU CP then sends the MB-UPF repetition timer value to the gNB-CU UP at step 3.

More particularly, the gNB-CU CP receives the MB-UPF repetition timer value for echo request from the MB-SMF at step 2 in signaling 135, it may be per TMGI, i.e., per broadcast session, or not. The MB-SMF 99-1 has been configured with this timer value or has received a value for this timer earlier from MB-UPF at step 1 in signaling 130. The gNB-CU CP further sends the MB-UPF repetition timer value for Echo request to the gNB-CU UP at step 3 in signaling 140.

The gNB-CU UP 110 detects the N3mb failure using this timer value at step 4 and blocks 150 and 151. The CU UP 110 notifies gNB-CU CP 115 at step 5 in signaling 155. The gNB-CU CP triggers new N3mb setup at step 6, and in block 160.

In Option 1c, the MB-UPF 99-2 sends a downlink packet over N3mb or an echo request message over N3mb, which includes an indication of a value for the MB-UPF repetition timer, see signaling 145. An indication of the “TMGI 1” may also be included if this repetition timer value is per MBS Session (TMGI). This downlink packet can be the first downlink packet of the broadcast session (respectively echo request message) but not necessarily. The gNB-CU UP 110 detects the N3mb failure using this timer value at step 4 and blocks 150 and 151. The CU UP 110 notifies gNB-CU CP 115 at step 5 in signaling 155. The gNB-CU CP triggers new N3mb setup at step 6, and in block 160.

Embodiment 2 is now described. One idea for embodiment 2 is to rely on element(s) in the core network, e.g., 5GC, to resolve the N3mb failure. The starting point in an example is that the MB-UPF detects the N3mb failure.

Embodiment 2a, which is for a non-RAN-sharing case is now described in reference to FIG. 2A, which is a signaling diagram for N3 MB failure recovery with a non-RAN-sharing case.

As an overview, upon receiving the MB-UPF notification that N3mb failed (including the gNB IP address towards which an N3mb path failure is detected), the MB-SMF instructs the AMF to send a broadcast session release request towards the corresponding gNB including indication of a cause about the user plane N3mb failure. The gNB-CU CP releases the broadcast session and informs back the 5GC (e.g., core network 90) that the CU CP cannot set up any other N3mb (e.g., due to the absence of RAN sharing). As a result, the MB-SMF triggers another broadcast session setup towards the gNB.

More details for signaling are as follows.

Step 1: In signaling 202, the MB-UPF 99-2 informs the MB-SMF 99-1 of the N3mb failure, including relevant IP address (associated with gNB 70). For the times when the MB-UPF 99-2 indicates the N3mb failure to the MB-SMF 99-1, this is performed with an IP address (the one associated with the gNB). When other addresses are referred to herein, these refer to transport addresses.

Step 2: Upon receiving the MB-UPF notification that N3mb failed (including an IP address of the gNB 70), the MB-SMF 99-1 instructs the AMF 99-3 to send a broadcast session release request towards the corresponding gNB including indication of a cause about the user plane N3mb failure. This occurs in part in block 204, where the MB-SMF retrieves the corresponding gNB ID and instructs the AMF to release the current broadcast session. In more detail, the MB-SMF 99-1 knows the mapping between IP address used in MB UPF and the corresponding gNB ID. The MB-SMF 99-1 generates the broadcast release request but needs to tell the AMF towards which gNB to send this broadcast release request.

Steps 3,4,5: The MB-SMF 99-1 sends an update message to the AMF 99-3 in signaling 206 for step 3, including indications of the TMGI, the gNB ID, and N3mb failure. The gNB-CU CP 115 receives (signaling 208) an NGAP broadcast (bcast) session release messaging comprising indications of the TMGI and N3mb failure, and releases (block 209) the broadcast session and indicates (signaling 210) back to the 5GC that it cannot set up any other N3mb (cause: no N3mb in this example, although no RAN sharing could also be used). Signaling 210 is from the CU CP 115 to the AMF 99-3 and through the AMF to the MB-SMF 99-1. The CU CP 115 also signals to the CU UP 110 an ElAP broadcast release request with an indication of the TMGI, see signaling 212.

Concerning the update message in signaling 206, the MB-SMF 99-1 builds a broadcast release request (or modification request as in FIG. 2B, described below) and encapsulates this in a generic “update” message that the MB-SMF sends to the AMF. The AMF then relays the message. Therefore, for example, the request for a new transport address (as in FIG. 2B) doesn't need to be known by AMF 99-3, as the AMF can relay the broadcast release request from the MB-SMF, which is configured to request a new transport address, which is a transport address.

Step 6: As a result of the previous signaling, the MB-SMF 99-1 instructs the AMF 99-3 to trigger another broadcast session setup request towards the gNB, via block 214 and an instruction to the AMF to set up another broadcast session as in signaling 216.

Steps 7,8: The gNB receives the signaling 216 and, in response, sets up (block 217) a new broadcast session. The MB-SMF 99-1 signals to the CU CP 115, through the AMF 99-3, an NGAP broadcast set up request in signaling 216. In signaling 218, the CU CP 115 responds to the MB-SMF 99-1, through the AMF 99-3, with an NGAP broadcast setup response message, which includes indication of MBS session information, e.g., including a (new) transport address. In signaling 220 for step 8, the CU CP 115 also sends an ElAP broadcast setup request message indicating the (new) TMGI.

Embodiment 2b, for the non-RAN-sharing case, is described now. See FIG. 2B, which is a signaling diagram for an example referred to as embodiment 2b for N3 MB failure recovery with a non-RAN-sharing case.

As an overview, upon receiving the MB-UPF notification that N3mb failed (including the gNB IP address towards which an N3mb path failure is detected), the MB-SMF instructs the AMF to send a broadcast session modification request towards the corresponding gNB including a request for new N3mb transport address, optionally with indications of a cause indicating N3mb failure. The cause may also serve an implicit indication for the request of new N3mb transport address (instead of an explicit indication).

The gNB-CU CP retrieves a new transport address for the broadcast session from gNB-CU UP and asks the gNB-CU UP to switch. The gNB-CU CP sends back the new transport address to 5GC in NGAP broadcast modification response message. The MB-SMF instructs the MB-UPF to start delivering the MBS data towards the new gNB transport address (and to stop delivering MBS data towards the old gNB transport address). Part of the techniques herein involve transport addresses, i.e., how to get a new transport address over N3mb from the gNB for the broadcast session. A transport address is typically an IP address (associated with the gNB) and a GTP tunnel endpoint (of the gNB) used by the broadcast session to deliver data over N3mb (data is only downlink).

Examples of descriptions of the various steps are as follows.

Step 1: MB-UPF informs the MB-SMF of the N3mb failure, including relevant IP address of the gNB. This is previously described as signaling 202.

Step 2: Upon receiving the MB-UPF notification that N3mb failed (e.g., the IP address of the gNB), the MB-SMF 99-1 instructs the AMF 99-3 to send a broadcast session modification request towards corresponding gNB including a request (ask) for a new transport address, optionally with indication of a cause indicating N3mb failure. See block 221.

Steps 3,4: Upon receiving the broadcast session modification request message from the AMF 99-3, the gNB-CU CP 115 retrieves a new transport address for the broadcast session from gNB-CU UP and also asks the gNB-CU UP to switch to the new transport address for the receiving data of the broadcast session. As previously described, the signaling 223 of the update message can be configured with a modification request, which in this example at least requests a new transport address as a transport address. The modification request is encapsulated in the update message in the signaling 223, and this is relayed by the AMF 99-3 in the signaling 222. That is, in signaling 222, the AMF 99-3 sends to the CU CP 115 an NGAP broadcast session modification request message to the CU CP 115 indicating at least one of the TMGI of the broadcast session, the request for a new transport address, and N3mb failure indication. The CU CP 115 also sends an ElAP broadcast modification request with indication of the TMGI and a switch to the new transport address in signaling 224. The CU UP 110 also sends an ElAP broadcast modification response message indicating the new transport address to the CU CP 115 in signaling 226.

Step 5: The gNB-CU CP 115 sends back the new transport address to the 5GC in an NGAP broadcast modification response message. This signaling 228 passes through the AMF 99-3 and ends at the MB-SMF 99-1.

Step 6: The MB-SMF 99-1 forwards, in signaling 230, the new transport address received from gNB-CU CP to the MB-UPF 99-2.

It is noted that this set of steps results in the same broadcast session being used, but with a new transport address (which provides an IP address associated with the gNB 70 along with a GTP tunnel endpoint associated with the gNB 70).

Another embodiment, embodiment 2c, which involves RAN sharing and non-RAN-sharing cases, is now described in FIG. 2C. As an overview, upon receiving the MB-UPF notification that N3mb failed (including the gNB IP address towards which an N3mb path failure is detected), the MB-SMF instructs the AMF to notify the corresponding gNB that N3mb failed. Upon receiving the MB-SMF notification, the gNB CU CP can act upon, that is, trigger, a new N3mb set up towards 5GC (MB-SMF) of same or another PLMN. In FIG. 2C, the AMF 1 99031, MB-SMF 1 99-11 and MB-UPF 99-21 are in PLMN 1 290-1 and the AMF 2 99-32, MB-SMF 2 99-12, and MB-UPF 2 99-22 are in the PLMN 290-2.

Examples of the steps involved are as follows.

Step 1: MB-UPF 1 informs the MB-SMF 1 of the N3mb failure, including relevant IP address (of the corresponding gNB). This is signaling 202.

Step 2: Upon receiving the MB-UPF notification that N3mb failed (e.g., with indication of the IP address), MB-SMF 1 99-11 instructs the AMF to notify the corresponding gNB that N3mb failed. Sec block 232. Again, this may be performed by the MB-SMF 1 99-11 configuring the update message in signaling 233 to encapsulate a broadcast (bcast) session notify (or notification) failure, which the AMF 99-3 then passes through to the CU CP 115.

Steps 3,4: Upon receiving the N3mb failure notification from MB-SMF/AMF, the gNB CU CP releases the previous downlink transport address towards the gNB-CU UP. This involves the AMF 99-3 receiving the update message with indication of at least one of TMGI, gNB ID, and N3mb failure, in signaling 233, then forwarding an NGAP broadcast session notify (or notification) message, with indication of TMGI and N3mb failure, to the CU CP 115, in signaling 235. In block 234, the CU CP 115 decides to release the relevant current transport address associated with this broadcast session and then to get a new one. This involves sending an ElAP broadcast release request, with indication of TMGI, to the CU UP 110, using signaling 236.

Steps 5,6: In response to receiving the N3mb failure notification from MB-SMF/AMF, the gNB-CU CP 115 fetches a new transport address (via signaling 240)—please note that signaling 236 and 240 may be combined—and triggers the new N3mb setup towards MB-SMF 2 99-12 of another PLMN (or could be towards MB-SMF 1 99-11 again of the same PLMN, as in block 239) including the new transport address. See block 238 where IP address means more generally “transport address”=IP address+tunnel endpoint. The triggering uses signaling 242, which involves and NGAP broadcast session transport request with indication of the new transport address, from the CU CP 115 to the AMF 2 99-32, and through the AMF 99-32 to the MB-SMF 99-12. Step 6 sends the new transport address from the MB-SMF 2 99-12 to the MB-UPF 99-22.

Embodiment 2d, which involves RAN-sharing and non-RAN sharing cases, is now described in FIG. 2D. As an overview, upon receiving the MB-UPF notification that N3mb failed (including the gNB IP address towards which an N3mb path failure is detected), the MB-SMF instructs the AMF to send a broadcast session release request towards the corresponding gNB including an indicated cause about the user plane N3mb failure. The gNB-CU CP releases the broadcast session and triggers the N3mb setup with the 5GC of same or another PLMN.

The steps may be described as follows in FIG. 2D. In FIG. 2D, the AMF 1 99031, MB-SMF 1 99-11 and MB-UPF 99-21 are in PLMN 1 290-1 and the AMF 2 99-32, MB-SMF 2 99-12, and MB-UPF 2 99-22 are in the PLMN 290-2.

Step1: MB-UPF informs the MB-SMF of the N3mb failure, including relevant IP address. This is signaling 202.

Step 2: Upon receiving the MB-UPF notification that N3mb failed (IP address of the gNB), the MB-SMF 1 99-11 instructs the AMF to send a broadcast session release request including a new cause about the user plane N3mb failure. Sec block 250. The signaling 244 of the update message can be configured with a session release request, which is then passed through the AMF in signaling 246.

Steps 3,4: Upon receiving the broadcast session release request with N3mb failure cause from MB-SMF/AMF, the gNB CU CP 115 releases the previous downlink transport address towards the gNB-CU UP. See block 234. This also involves the update message in signaling 244, with indication of at least one of TMGI, gNB ID, N3mb failure, and the AMF 99-3 sending an NGAP broadcast session release in signaling 246 with indication of TMGI and N3mb failure. The CU CP 115 sends an NGAP broadcast release response in signaling 244 with indication of TMGI to the MB-SMF 1 99-11. The CU CP 115 also sends an ElAP broadcast release message request, in signaling 236 with indication of TMGI, to the CU UP 110.

Steps 5, 6: Upon receiving the broadcast session release request with N3mb failure cause from MB-SMF/AMF, the gNB CU CP 110 fetches a new transport address and triggers (block 238) the new N3mb setup towards MB-SMF 2 99-12 of another PLMN (or could be towards MB-SMF 1 99-11 again of same PLMN, see block 239) including the new transport address. This occurs in signaling 240 between the CU UP 110 and CU CP 115, and in signaling 242 with an NGAP broadcast session transport request with indication of the new transport address. That is, the triggering uses signaling 242, which involves and NGAP broadcast session transport request with indication of the new transport address, from the CU CP 115 to the AMF 2 99-32, and through the AMF 99-32 to the MB-SMF 99-12. Step 6 sends the new transport address from the MB-SMF 2 99-12 to the MB-UPF 99-22.

Turning to FIG. 3, this figure shows a block diagram of one possible and non-limiting example of a cellular network 1 that is connected to a user equipment (UE) 10. A number of network elements are shown in the cellular network of FIG. 3: a gNB 70; and a core network 90. In FIG. 3, a user equipment (UE) 10 is in wireless communication via radio link 11 with the gNB 70 of the cellular network 1. The gNB 70 is a network access node of the cellular network 1, as the gNB provides access to the cellular network 1 by the UE or UEs 10.

This example illustrates a “monolithic” gNB 70, as one “block” of circuitry and corresponding program information. As described above, however, the gNB 70 could be a split gNB, with higher layers split into the CU UP 110 and CU CP 115, and lower layers split into DU(s) (possibly with RU(s)) 71. The program 72, processor(s) 73, memories 75, and other circuitry 76 are in each of the elements 71, 110, 115. The RF part (77 and 78) of the gNB 70 is implemented in the DU/RU, which communicates over the radio link 11. The elements 71, 110, and 115 communicate using link(s) 74. One example is the ElAP that is referred to above.

A UE 10 is a wireless communication device, such as a mobile device, that is configured to access a cellular network. The UE 10 is illustrated with one or more antennas 28. The ellipses 2 indicate there could be multiple UEs 10 in wireless communication via radio links with the gNB 70. The UE 10 includes one or more processors 13, one or more memories 15, and other circuitry 16. The other circuitry 16 includes one or more receivers (Rx(s)) 17 and one or more transmitters (Tx(s)) 18. A program 12 is used to cause the UE 10 to perform the operations described herein. For a UE 10, the other circuitry 16 could include circuitry such as for user interface elements (not shown) like a display.

The gNB 70, as a network element of the cellular network 1, provides the UE 10 access to cellular network 1 and to the data network 91 via the core network 90 (e.g., via a user plane function (UPF) of the core network 90). As such, the gNB 70 can be considered to be the network access node (as previously described) and be considered to be a base station. The gNB 70 is illustrated as having one or more antennas 58. In general, the gNB 70 may be referred to as RAN node 70, although many will make reference to this as a gNB (gNode B, a base station for NR, new radio) instead. There are, however, many other examples of RAN nodes including an eNB (evolved Node B) or TRP (Transmission-Reception Point). The gNB 70 includes one or more processors 73, one or more memories 75, and other circuitry 76. The other circuitry 76 includes one or more receivers (Rx(s)) 77 and one or more transmitters (Tx(s)) 78. A program 72 is used to cause the gNB 70 to perform the operations described herein.

It is noted that the gNB 70 may instead be implemented via other wireless technologies, such as Wi-Fi (a wireless networking protocol that devices use to communicate without direct cable connections). In the case of Wi-Fi, the link 11 could be characterized as a wireless link.

Two or more gNBs 70 communicate using, e.g., link(s) 79. The link(s) 79 may be wired or wireless or both and may implement, e.g., an Xn interface for 5G (fifth generation), an X2 interface for LTE (Long Term Evolution), or other suitable interface for other standards.

The cellular network 1 may include a core network 90, as a second element or set of elements, that may include core network functionality, and which provide connectivity via a link or links 81 with a data network 91, such as a telephone network and/or a data communications network (e.g., the Internet). The core network 90 includes one or more processors 93, one or more memories 95, and other circuitry 96. The other circuitry 96 includes one or more receivers (Rx(s)) 97 and one or more transmitters (Tx(s)) 98. A program 92 is used to cause the core network 90 to perform the operations described herein.

The core network 90 could be a 5GC (5G core network). The core network 90 can implement or comprise multiple elements 99, also referred to as elements, also referred to as network functions (NF(s)) 99, and the program 92 may comprise one or more of the NFs 99. The elements 99 may be individual computing systems or network functions, which are themselves implemented by computing systems. In more detail, a 5G core network may use hardware such as memory and processors and a virtualization layer. It could be a single standalone computing system, a distributed computing system, or a cloud computing system. The NFs 99 of the core network 90 could be containers or virtual machines running on the hardware of the computing system(s) making up the core network 90.

Core network functionality for 5G may include access and mobility management functionality that is provided by a network function 99 such as an access and mobility management function (AMF(s)), session management functionality that is provided by a network function such as a session management function (SMF). Core network functionality for access and mobility management in an LTE (Long Term Evolution) network may be provided by an MME (Mobility Management Entity) and/or SGW (Serving Gateway) functionality, which routes data to the data network. Many others are possible, as illustrated by the examples in FIG. 3: AMF; SMF; MME; SGW; GMLC (Gateway Mobile Location Center); LMF (Location Management Function); UDM (Unified Data Management)/UDR (Unified Data Repository); NRF (Network Repository Function); and/or E-SMLC (Evolved Serving Mobile Location Center). The MB-SMF (1, 2) and the MB-UPF (1) are also included. Note that these would be structured as MB-SMF (1) and the MB-UPF (1) for one core network 90 and its corresponding PLMN 290, and MB-SMF (2) for a different core network 90 and its corresponding PLMN 290. These are merely exemplary core network functionality that may be provided by the core network 90, and note that both 5G and LTE core network functionality might be provided by the core network 90. The gNB 70 is coupled via a backhaul link 31 to the core network 90. The gNB 70 and the core network 90 may include an NG (Next Generation) interface for 5G, or an SI interface for LTE, or other suitable interface for other radio access technologies for communicating via the backhaul link 31.

In the data network 91, there is a computer-readable medium 94. The computer-readable medium 94 contains instructions that, when downloaded and installed into the memories 15, 75, or 95 of the corresponding UE 10, gNB 70, and/or core network element(s) 90, and executed by processor(s) 13, 73, or 93, cause the respective device to perform corresponding actions described herein. The computer-readable medium 94 may be implemented in other forms, such as via a compact disc or memory stick.

The programs 12, 72, and 92 contain instructions stored by corresponding one or more memories 15, 75, or 95. These instructions, when executed by the corresponding one or more processors 13, 73, or 93, cause the corresponding apparatus 10, 70, or 90, to perform the operations described herein. The computer readable memories 15, 75, or 95 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 15, 75, and 95 may be means for performing storage functions. The processors 13, 73, and 93, may be of any type suitable to the local technical environment, and may include one or more of general-purpose computers, special purpose computers, microprocessors, digital signal processors (DSPs) and processors based on a multi-core processor architecture, as non-limiting examples. The processors 13, 73, and 93 may be means for causing their respective apparatus to perform functions, such as those described herein.

The receivers 17, 77, and 97, and the transmitters 18, 78, and 98 may implement wired or wireless interfaces. The receivers and transmitters may be grouped together as transceivers.

The cellular network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities (such as network functions 99) that result from the network virtualization are still implemented, at some level, using hardware such as processors 73 and/or 93 and memories 75 and/or 95, and also such virtualized entities create technical effects.

Without in any way limiting the scope, interpretation, or application of the claims appearing below, a technical effect and/or advantage of one or more of the example embodiments disclosed herein involves the following. If the NG-RAN is the split architecture, and for the second trigger described above, only the gNB-CU-UP is aware if there is DL data stream from the CN. Therefore, the new message should be triggered by the gNB-CU-UP originally. The gNB-CU-UP notifies there is no data transmission to the gNB-CU-CP due to failure in the user plane. Then the gNB CU-CP can send the message to another core network.

The following are additional examples.

Example 1. A method, comprising: receiving, by a network access node in a cellular network, an indication of an interval between expected receptions of echo requests that pass through a tunnel that uses an interface between a network element in a core network of the cellular network to the network access node of the cellular network; determining, by the network access node, a threshold time period based on the interval; detecting, by the network access node, there has been no echo request for a time period greater than the threshold time period;

determining, by the network access node from the detecting, a failure of the tunnel that uses the interface; and triggering, by the network access node, set up of a new tunnel using the interface due to the failure of the tunnel.

Example 2. The method according to example 1, wherein the receiving the indication of the interval comprises receiving a configured interval to be used as the indicated interval from an O&M (operation and maintenance) system.

Example 3. The method according to example 1, wherein receiving the indication of the interval comprises receiving the indication of the interval from a session management function or a multicast broadcast session management function.

Example 4. The method according to example 1, wherein the receiving the indication of the interval comprises receiving the indication of the interval from a user plane function or a multicast broadcast user plane function.

Example 5. The method according to example 4, wherein the indication of the interval is received from the user plane function or a multicast broadcast user plane function via a session management function or a multicast broadcast session management function.

Example 6. The method according to example 4, wherein the indication of the interval is received from the user plane function or a multicast broadcast user plane function in a data packet or an echo request message from sent by the user plane function or a multicast broadcast user plane function.

Example 7. The method according to any of examples 1 to 6, wherein the indication of the interval is per multicast broadcast service (MBS) session.

Example 8. The method according to any of examples 1 to 6, wherein the network access node comprises a first unit for a user plane and a second unit for a control plane, and wherein: the method further comprises indicating, by the first unit to the second unit, the failure of the tunnel; and the triggering set up of a new tunnel is performed by the second unit.

Example 9. A method, comprising: receiving, from a first network element in a core network of a cellular network and by a second network element in the core network, an indication that a tunnel for an interface used for communicating an MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further requesting a release of the MBS session.

Example 10. The method according to example 9, wherein the indicating further indicates a cause value indicating that an interface over which the MBS session is communicated has failed.

Example 11. The method according to any of examples 9 or 10, further comprising: receiving, by the second network element, indication from the network access node that the MBS session has been released; and requesting, by the second network element towards the network access node via the third network element, another setup of the MBS session.

Example 12. A method, comprising: receiving, by a network access node using a tunnel of an interface for communicating an MBS session between the network access node and a first network element in a core network and from a second network node via a third network element in the core network, an indication that the tunnel has failed, the indication further indicating the MBS session is to be released; releasing, by the network access node, the MBS session; and sending, by the network access node toward a second network element via the third network element in the core network, indication that the interface is no longer being used for this MBS session and that the MBS session is released.

Example 13. A method, comprising: receiving, from a first network element in a core network of a cellular network and by a second network element in the core network, an indication that a tunnel for an interface used for communicating a MBS session between a network access node and the first network element has failed, the indication comprising indication of an address associated with the network access node using the tunnel; retrieving, by the second network element, an identification of the network access node based on the address; and indicating, by the second network element to a third network element for forwarding to the network access node, at least one of failure of the tunnel in the core network, or a request for a new transport address of the network access node for use as new tunnel endpoint for the MBS session.

Example 14. The method according to example 13, wherein the indicating further indicates at least one of that a tunnel of an interface over which the MBS session is communicated has failed or an identification of the MBS session.

Example 15. The method according to any of examples 13 or 14, further comprising: receiving, by the second network element, indication of a new transport address to be used as tunnel endpoint that is associated with the MBS session.

Example 16. A method, comprising: receiving, by a network access node using a tunnel of an interface for communicating a MBS session between the network access node and a first network element in a core network and from a second network node via a third network element in the core network, at least one of an indication that the tunnel has failed, or an indication indicating a request for a new transport address to be used as tunnel endpoint for the MBS session; determining, by the network access node, a new transport address associated with the MBS session; and sending, by the network access node toward a second network element via the third network element in the core network, indication of the new transport address that is associated with the MBS session to be used as new tunnel endpoint for the communicating between the first network element and the network access node.

Example 17. A method, comprising: receiving, from a first network element in a core network of a cellular network and by a second network element in the core network, an indication that a tunnel for an interface used for communicating an MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further having a notification about the MBS session being associated with the tunnel has failed.

Example 18. A method, comprising: receiving, by a network access node using a tunnel of an interface for communicating an MBS session between the network access node and a first network element in a core network and from a second network element via a third network element in the core network, an indication that the tunnel has failed; determining, by the network access node, to release a current transport address associated with the MBS session and get a new transport address for the MBS session; and setting up, by the network access node, a new tunnel that uses the interface used for communicating the MBS session with a current PLMN for the core network or an other PLMN for an other core network; and sending, by the network access node toward one of a second network element in the core network of the current PLMN or a second network element in the other core network of the other PLMN, indication of the new transport address to be used with the new tunnel for the MBS session.

Example 19. A method, comprising: receiving, from a first network element in a core network of a cellular network and by a second network element in the core network, an indication that a tunnel for an interface used for communicating a MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further having a notification about the MBS session being associated with the tunnel has failed and requesting release of the MBS session.

Example 20. A method, comprising: receiving, by a network access node using a tunnel of an interface for communicating a MBS session between the network access node and a first network element in a core network and from a second network element via a third network element in the core network, an indication that the tunnel has failed and requesting release of the MBS session; determining, by the network access node, to release a current transport address associated with the MBS session and get a new transport address for the MBS session; and setting up, by the network access node, a new tunnel that uses the interface used for communicating the MBS session toward one of a second network element in the core network of a current PLMN or a second network element in the core network of another PLMN; and sending, by the network access node toward the one of a second network element in the core network for the current PLMN or the one of a second network element in the other core network for the other PLMN, indication of the new transport address to be used with the new tunnel for the MBS session.

Example 21. The method according to any of the method examples, wherein network elements are network functions in the core network.

Example 22. A computer program, comprising instructions for performing the methods of any of examples 1 to 21, when the computer program is run on an apparatus.

Example 23. The computer program according to example 22, wherein the computer program is a computer program product comprising a computer-readable medium bearing instructions embodied therein for use with the apparatus.

Example 24. The computer program according to example 22, wherein the computer program is directly loadable into an internal memory of the apparatus.

Example 25. An apparatus, comprising means for performing: receiving, by a network access node in a cellular network, an indication of an interval between expected receptions of echo requests that pass through a tunnel that uses an interface between a network element in a core network of the cellular network to the network access node of the cellular network; determining, by the network access node, a threshold time period based on the interval; detecting, by the network access node, there has been no echo request for a time period greater than the threshold time period; determining, by the network access node from the detecting, a failure of the tunnel that uses the interface; and triggering, by the network access node, set up of a new tunnel using the interface due to the failure of the tunnel.

Example 26. The apparatus according to example 25, wherein the receiving the indication of the interval comprises receiving a configured interval to be used as the indicated interval from an O&M (operation and maintenance) system.

Example 27. The apparatus according to example 25, wherein receiving the indication of the interval comprises receiving the indication of the interval from a session management function or a multicast broadcast session management function.

Example 28. The apparatus according to example 25, wherein the receiving the indication of the interval comprises receiving the indication of the interval from a user plane function or a multicast broadcast user plane function.

Example 29. The apparatus according to example 28, wherein the indication of the interval is received from the user plane function or a multicast broadcast user plane function via a session management function or a multicast broadcast session management function.

Example 30. The apparatus according to example 28, wherein the indication of the interval is received from the user plane function or a multicast broadcast user plane function in a data packet or an echo request message from sent by the user plane function or a multicast broadcast user plane function.

Example 31. The apparatus according to any of examples 25 to 30, wherein the indication of the interval is per multicast broadcast service (MBS) session.

Example 32. The apparatus according to any of examples 25 to 30, wherein the network access node comprises a first unit for a user plane and a second unit for a control plane, and wherein: the means are further configured for performing: indicating, by the first unit to the second unit, the failure of the tunnel; and the triggering set up of a new tunnel is performed by the second unit.

Example 33. An apparatus, comprising means for performing: receiving, from a first network element in a core network of a cellular network and by a second network element in the core network, an indication that a tunnel for an interface used for communicating an MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further requesting a release of the MBS session.

Example 34. The apparatus according to example 33, wherein the indicating further indicates a cause value indicating that an interface over which the MBS session is communicated has failed.

Example 35. The apparatus according to any of examples 33 or 34, wherein the means are further configured for performing: receiving, by the second network element, indication from the network access node that the MBS session has been released; and requesting, by the second network element towards the network access node via the third network element, another setup of the MBS session.

Example 36. An apparatus, comprising means for performing: receiving, by a network access node using a tunnel of an interface for communicating an MBS session between the network access node and a first network element in a core network and from a second network node via a third network element in the core network, an indication that the tunnel has failed, the indication further indicating the MBS session is to be released; releasing, by the network access node, the MBS session; and sending, by the network access node toward a second network element via the third network element in the core network, indication that the interface is no longer being used for this MBS session and that the MBS session is released.

Example 37. An apparatus, comprising means for performing: receiving, from a first network element in a core network of a cellular network and by a second network element in the core network, an indication that a tunnel for an interface used for communicating a MBS session between a network access node and the first network element has failed, the indication comprising indication of an address associated with the network access node using the tunnel; retrieving, by the second network element, an identification of the network access node based on the address; and indicating, by the second network element to a third network element for forwarding to the network access node, at least one of failure of the tunnel in the core network, or a request for a new transport address of the network access node for use as new tunnel endpoint for the MBS session.

Example 38. The apparatus according to example 37, wherein the indicating further indicates at least one of that a tunnel of an interface over which the MBS session is communicated has failed or an identification of the MBS session.

Example 39. The apparatus according to any of examples 37 or 38, wherein the means are further configured for performing: receiving, by the second network element, indication of a new transport address to be used as tunnel endpoint that is associated with the MBS session.

Example 40. An apparatus, comprising means for performing: receiving, by a network access node using a tunnel of an interface for communicating a MBS session between the network access node and a first network element in a core network and from a second network node via a third network element in the core network, at least one of an indication that the tunnel has failed, or an indication indicating a request for a new transport address to be used as tunnel endpoint for the MBS session; determining, by the network access node, a new transport address associated with the MBS session; and sending, by the network access node toward a second network element via the third network element in the core network, indication of the new transport address that is associated with the MBS session to be used as new tunnel endpoint for the communicating between the first network element and the network access node.

Example 41. An apparatus, comprising means for performing: receiving, from a first network element in a core network of a cellular network and by a second network element in the core network, an indication that a tunnel for an interface used for communicating an MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further having a notification about the MBS session being associated with the tunnel has failed.

Example 42. An apparatus, comprising means for performing: receiving, by a network access node using a tunnel of an interface for communicating an MBS session between the network access node and a first network element in a core network and from a second network element via a third network element in the core network, an indication that the tunnel has failed; determining, by the network access node, to release a current transport address associated with the MBS session and get a new transport address for the MBS session; and setting up, by the network access node, a new tunnel that uses the interface used for communicating the MBS session with a current PLMN for the core network or an other PLMN for an other core network; and sending, by the network access node toward one of a second network element in the core network of the current PLMN or a second network element in the other core network of the other PLMN, indication of the new transport address to be used with the new tunnel for the MBS session.

Example 43. An apparatus, comprising means for performing: receiving, from a first network element in a core network of a cellular network and by a second network element in the core network, an indication that a tunnel for an interface used for communicating a MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further having a notification about the MBS session being associated with the tunnel has failed and requesting release of the MBS session.

Example 44. An apparatus, comprising means for performing: receiving, by a network access node using a tunnel of an interface for communicating a MBS session between the network access node and a first network element in a core network and from a second network element via a third network element in the core network, an indication that the tunnel has failed and requesting release of the MBS session; determining, by the network access node, to release a current transport address associated with the MBS session and get a new transport address for the MBS session; and setting up, by the network access node, a new tunnel that uses the interface used for communicating the MBS session toward one of a second network element in the core network of a current PLMN or a second network element in the core network of another PLMN; and sending, by the network access node toward the one of a second network element in the core network for the current PLMN or the one of a second network element in the other core network for the other PLMN, indication of the new transport address to be used with the new tunnel for the MBS session.

Example 45. The apparatus according to any of the apparatus examples, wherein network elements are network functions in the core network.

Example 46. The apparatus of any preceding apparatus example, wherein the means comprises: at least one processor; and at least one memory storing instructions that, when executed by at least one processor, cause the performance of the apparatus.

Example 47. An apparatus, comprising: one or more processors; and one or more memories storing instructions that, when executed by the one or more processors, cause the apparatus at least to perform: receiving, by a network access node in a cellular network, an indication of an interval between expected receptions of echo requests that pass through a tunnel that uses an interface between a network element in a core network of the cellular network to the network access node of the cellular network; determining, by the network access node, a threshold time period based on the interval; detecting, by the network access node, there has been no echo request for a time period greater than the threshold time period; determining, by the network access node from the detecting, a failure of the tunnel that uses the interface; and triggering, by the network access node, set up of a new tunnel using the interface due to the failure of the tunnel.

Example 48. An apparatus, comprising: one or more processors; and one or more memories storing instructions that, when executed by the one or more processors, cause the apparatus at least to perform: receiving, from a first network element in a core network of a cellular network and by a second network element in the core network, an indication that a tunnel for an interface used for communicating an MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further requesting a release of the MBS session.

Example 49. An apparatus, comprising: one or more processors; and one or more memories storing instructions that, when executed by the one or more processors, cause the apparatus at least to perform: receiving, by a network access node using a tunnel of an interface for communicating an MBS session between the network access node and a first network element in a core network and from a second network node via a third network element in the core network, an indication that the tunnel has failed, the indication further indicating the MBS session is to be released; releasing, by the network access node, the MBS session; and sending, by the network access node toward a second network element via the third network element in the core network, indication that the interface is no longer being used for this MBS session and that the MBS session is released.

Example 50. An apparatus, comprising: one or more processors; and one or more memories storing instructions that, when executed by the one or more processors, cause the apparatus at least to perform: receiving, from a first network element in a core network of a cellular network and by a second network element in the core network, an indication that a tunnel for an interface used for communicating a MBS session between a network access node and the first network element has failed, the indication comprising indication of an address associated with the network access node using the tunnel; retrieving, by the second network element, an identification of the network access node based on the address; and indicating, by the second network element to a third network element for forwarding to the network access node, at least one of failure of the tunnel in the core network, or a request for a new transport address of the network access node for use as new tunnel endpoint for the MBS session.

Example 51. An apparatus, comprising: one or more processors; and one or more memories storing instructions that, when executed by the one or more processors, cause the apparatus at least to perform: receiving, by a network access node using a tunnel of an interface for communicating a MBS session between the network access node and a first network element in a core network and from a second network node via a third network element in the core network, at least one of an indication that the tunnel has failed, or an indication indicating a request for a new transport address to be used as tunnel endpoint for the MBS session; determining, by the network access node, a new transport address associated with the MBS session; and sending, by the network access node toward a second network element via the third network element in the core network, indication of the new transport address that is associated with the MBS session to be used as new tunnel endpoint for the communicating between the first network element and the network access node.

Example 52. An apparatus, comprising: one or more processors; and one or more memories storing instructions that, when executed by the one or more processors, cause the apparatus at least to perform: receiving, from a first network element in a core network of a cellular network and by a second network element in the core network, an indication that a tunnel for an interface used for communicating an MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further having a notification about the MBS session being associated with the tunnel has failed.

Example 53. An apparatus, comprising: one or more processors; and one or more memories storing instructions that, when executed by the one or more processors, cause the apparatus at least to perform: receiving, by a network access node using a tunnel of an interface for communicating an MBS session between the network access node and a first network element in a core network and from a second network element via a third network element in the core network, an indication that the tunnel has failed; determining, by the network access node, to release a current transport address associated with the MBS session and get a new transport address for the MBS session; and setting up, by the network access node, a new tunnel that uses the interface used for communicating the MBS session with a current PLMN for the core network or an other PLMN for an other core network; and sending, by the network access node toward one of a second network element in the core network of the current PLMN or a second network element in the other core network of the other PLMN, indication of the new transport address to be used with the new tunnel for the MBS session.

Example 54. An apparatus, comprising: one or more processors; and one or more memories storing instructions that, when executed by the one or more processors, cause the apparatus at least to perform: receiving, from a first network element in a core network of a cellular network and by a second network element in the core network, an indication that a tunnel for an interface used for communicating a MBS session between a network access node and the first network element has failed, the indication comprising indication of an address associated with the network access node using the tunnel; retrieving, by the second network element, an identification of the network access node based on the address; and indicating, by the second network element, failure of the tunnel to a third network element in the core network, for forwarding to the network access node, the indicating using at least the identification of the network access node, the indicating further having a notification about the MBS session being associated with the tunnel has failed and requesting release of the MBS session.

Example 55. An apparatus, comprising: one or more processors; and one or more memories storing instructions that, when executed by the one or more processors, cause the apparatus at least to perform: receiving, by a network access node using a tunnel of an interface for communicating a MBS session between the network access node and a first network element in a core network and from a second network element via a third network element in the core network, an indication that the tunnel has failed and requesting release of the MBS session; determining, by the network access node, to release a current transport address associated with the MBS session and get a new transport address for the MBS session; and setting up, by the network access node, a new tunnel that uses the interface used for communicating the MBS session toward one of a second network element in the core network of a current PLMN or a second network element in the core network of another PLMN; and sending, by the network access node toward the one of a second network element in the core network for the current PLMN or the one of a second network element in the other core network for the other PLMN, indication of the new transport address to be used with the new tunnel for the MBS session.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 3. A computer-readable medium may comprise a computer-readable storage medium (e.g., memories 15, 75, and 95 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
3GPP third generation partnership project
5G fifth generation
5GC fifth generation core
AMF access and mobility management function
bcast broadcast
CU CP Central Unit Control Plane
CU UP Central Unit User Plane
DU Distributed Unit
E-SMLC evolved serving mobile location center
GMLC Gateway Mobile Location Center
E1AP E1 application protocol
eNB (or eNodeB) evolved Node B (e.g., an LTE base station)
gNB (or gNodeB) base station for 5G/NR
GPRS General Packet Radio Service
GTP GPRS Tunnelling Protocol
I/F interface
IP Internet protocol
LMF Location Management Function
LTE long term evolution
MBS Multicast and Broadcast Services
MB-SMF Multicast Broadcast Session Management Function
MB-UPF Multicast Broadcast User Plane Function
MME mobility management entity
NF network function
ng or NG next generation
NGAP NG application protocol
NG-RAN next generation-radio access node
NR new radio
NRF Network Repository Function
N/W or NW network
PLMN public land mobile network
PTM Point to multipoint
RAN radio access network
Rel release
RF radio frequency
RRC radio resource control
RU radio unit
Rx receiver
SGW serving gateway
SMF session management function
SN Sequence Number
TMGI or tmgi Temporary Mobile Group Identifier
TRP transmission-reception point
Tx transmitter
UDM unified data management
UDR unified data repository
UE user equipment (e.g., a wireless, typically mobile device)
UPF user plane function

1. An apparatus for a core network of a cellular network, the apparatus comprising:
at least one processor; and
at least one memory storing instructions of a multicast broadcast session management function (MB-SMF), which when executed by the at least one processor, cause the apparatus to perform at least:
receiving, from a multicast broadcast user plane function (MB-UPF), an indication that a tunnel for an interface used for communicating a multicast broadcast services (MBS) session between a network access node and the MB-UPF has failed, the indication comprising an address associated with the network access node using the tunnel;
retrieving an identification of the network access node based on the address; and
indicating, to an access and mobility management function (AMF) for forwarding to the network access node, failure of the tunnel.

2. The apparatus as claimed in claim 1, wherein the indicating further comprising indicating an identification of the MBS session.

3. The apparatus as claimed in claim 1, wherein the MB-SMF is further configured to perform:
receiving an indication of a new transport address to be used as tunnel endpoint that is associated with the MBS session.

4. The apparatus as claimed in claim 1, wherein the indicating comprising indicating, to the AMF for forwarding to the network access node, failure of the tunnel using the identification of the network access node.

5. The apparatus of claim 4, wherein the indicating comprising indicating an identifier of the MBS session associated with the tunnel that has failed.

6. A network access node for a cellular network, the network access node comprising:
at least one processor; and
at least one memory storing instructions which, when executed by the at least one processor, cause the network access node to perform:
receiving, using a tunnel of an interface for communicating a multicast broadcast services (MBS) session between the network access node and a multicast broadcast user plane function (MB-UPF) and from a multicast broadcast session management function (MB-SMF) via an access and mobility management function (AMF), at least one of an indication that the tunnel has failed;
determining a new transport address associated with the MBS session; and
sending, toward the MB-SMF via the AMF, an indication of the new transport address that is associated with the MBS session to be used as new tunnel endpoint for the communicating between the MB-UPF and the network access node.

7. A network access node for a cellular network, the network access node comprising:
at least one processor; and
at least one memory storing instructions which, when executed by the at least one processor, cause the network access node to perform:
receiving, using a tunnel of an interface for communicating a multicast broadcast services (MBS) session of a core network of the cellular network between the network access node and a multicast broadcast user plane function (MB-UPF) of the core network and from a multicast broadcast session management function (MB-SMF) via an access and mobility management function (AMF) of the core network, an indication that the tunnel has failed;
determining to release a current transport address associated with the MBS session and get a new transport address for the MBS session;
setting up a new tunnel that uses the interface used for communicating the MBS session with another cellular network; and
sending, towards a multicast broadcast session management function (MB-SMF) of a core network of the another cellular network, an indication of the new transport address to be used with the new tunnel for the MBS session.
